(19) United States
(12) Patent Application Publication
(10) Pub. No.: US 2018/0274431 A1
(43) Pub. Date: Sep. 27, 2018

(54) COOLING CIRCUIT ARRANGEMENT AND METHOD FOR COOLING AN ENGINE

(71) Applicant: Kendrion (Markdorf) GmbH, Markdorf (DE)

(72) Inventors: Thomas Tauschel, Stockach (DE); David Vopel, Meckenbeuren (DE); Jan Von Hoyningen-Huene, Markdorf (DE); Martin Schwellinger, Überlingen (DE); Peter Klotz, Uhldingen/Mühlhofen (DE); Marco Kiene, Aach-Linz (DE)

(21) Appl. No.: 15/764,488

(22) PCT Filed: Aug. 4, 2016
(86) PCT No.: PCT/EP2016/068698

§ 371 Date: Mar. 29, 2018

(30) Foreign Application Priority Data
Oct. 2, 2015 (DE) 10 2015 116 749.2
May 2, 2016 (DE) 10 2016 108 143.4

(51) Int. Cl. F01P 7/16; F16K 31/06

(52) U.S. Cl. CPC F01P 7/167; F01P 2007/146; F16K 31/0637

(57) ABSTRACT

A cooling circuit arrangement (1) for cooling an engine (2), in particular a motor vehicle combustion engine, by means of a cooling medium, which can be conveyed by a cooling medium pump (4) between a suction side (S) and a pressure side (P) in a cooling medium circuit (3), which comprises a cooler fluid path (7) passing through a cooler (6) and a bypass fluid path (5), wherein a cooling medium valve (8) having an actuator (9) is arranged in the cooling medium circuit (3) for setting a volume flow ratio between cooling medium flows flowing through the cooler fluid path (7) and bypass fluid path (5), wherein the actuator (9) has a hydraulically activatable adjustment element (17), which can be supplied with a cooling medium via at least one control valve (11) allocated to the cooling medium valve (8), in particular from the pressure side (P) out of the cooling medium circuit (3), in order to set the volume flow ratio, and wherein the adjustment element (17) borders a control chamber (19) that can be supplied with cooling medium via the at least one control valve (11), and a valve chamber (20) also supplied with cooling medium, wherein the adjustment element (17) can be displaced in both mutually opposed displacement directions exclusively through exposure to hydraulic pressure by means of the cooling medium, and wherein, in order to displace the adjustment element (11), both the control chamber (19) and valve chamber (20) can be joined with the cooling circuit (3) by means of the at least one control valve (11), or the free flow cross section of corresponding connections can be varied, and that wherein, in order to maintain an adjustment position, the at least one control valve (11) can be used to join both the control chamber (19) and valve chamber (20) with the same cooling circuit side, or the free flow cross section of corresponding connections can be varied, wherein, the at least one control valve (11) has a 4/3-way valve functionality and a pressure-side cooling medium pressure port (P), a cooling medium outflow port (T), a first working port (B) leading to the control chamber (19) and a second working port (A) leading to the valve chamber (20).

### BACKGROUND OF THE INVENTION

The invention relates to a cooling circuit arrangement for cooling an engine, in particular a motor vehicle combustion engine, by means of a cooling medium, in particular water or oil, which can be conveyed by a cooling medium pump, in particular one that can be driven mechanically by the engine, between a suction side and a pressure side in a cooling medium circuit, which comprises a cooler fluid path passing through a cooler (radiator) and a bypass fluid path (that bypasses at least sections of the cooler), wherein a cooling medium valve having an actuator is arranged in the cooling medium circuit for setting a volume flow ratio between cooling medium flows flowing through the cooler fluid path and bypass fluid path. The invention further relates to a method for cooling an engine, in particular a motor vehicle combustion engine, preferably by means of a cooling circuit arrangement according to the invention, wherein cooling medium is conveyed between a suction side and a pressure side in a cooling medium circuit, which comprises a cooler fluid path passing through a cooler (radiator) and a bypass fluid path (that bypasses at least sections of the cooler), wherein a cooling medium valve having an actuator is arranged in the cooling medium circuit for setting a volume flow ratio between cooling medium flows flowing through the cooler fluid path and bypass fluid path.

The cooling medium temperature of combustion engines has up to now been regulated with a thermostat valve, which regulates the portion of cooling water flow that is pumped through the cooler (radiator). The most widespread are thermostat valves with expansion elements, which proportionally open and close the thermostat valve as a function of the coolant temperature arising at this location. Temperature regulating capability was improved by electrically heating the expansion element as needed in so-called map-controlled thermostat valves, so that a control unit can be used to shift the working range of a correspondingly equipped cooling circuit arrangement toward a lower working temperature.

Occasional use was also made of electromagnetic cooling medium valves, so as to switch or steer the cooling medium flow in smaller coolant flow branches. The use of rotary slide valves controlled by an electric motor as cooling medium valves has also become known. The applicant is also aware that pneumatically actuated cooling medium valves were occasionally used.

The problem with all cooling medium valves is the requisite good seal of the pressurized valve chambers. In addition, the structural design of known cooling circuit arrangements is complex and not very robust. Also disadvantageous in the known electromagnetic actuators of cooling medium valves is their comparatively high weight and the high costs. The assembly space for known cooling medium valves with corresponding actuators is also comparatively large.

### SUMMARY OF THE INVENTION

DE 10 2012 018 105 A1 (Thermostat Valve with Expansion Element), DE 20 2004 018 136 U1 and DE 10 2008 032 494 A1 are cited as published prior art.

Proceeding from the aforementioned prior art, the object of the invention is thus to indicate a cooling circuit arrangement that has a simple structural design on the one hand, and further requires less assembly space. Possible errors are also to be reduced to a minimum; in particular, the requirements placed on the seal of the cooling medium valve are to be slight. The cooling medium valve of the cooling circuit arrangement according to the invention is preferably to be designed in such a way that the cooling medium valve can be actuated in specific operating states, independently of the cooling medium temperature or an engine oil temperature.

The object of the invention is further to indicate a correspondingly improved method for cooling an engine.

This object is achieved with respect to the cooling circuit arrangement with the features disclosed herein, i.e., given a generic cooling circuit arrangement, by having the hydraulic actuator have a hydraulically actuatable adjustment element, which can be supplied with cooling medium via at least one control valve allocated to the cooling medium valve, in particular from the pressure side (of the cooling medium circuit), in order to set the volume flow ratio (between the cooling medium volume flow flowing through the cooler fluid path and the cooling medium volume flow flowing through the bypass fluid path).

With respect to the method, the object is achieved with the features disclosed herein, i.e., in a generic method, by having the actuator have a hydraulically actuatable adjustment element, which is supplied with cooling medium from the pressure side in order to set the volume flow ratio via a control valve allocated to the cooling medium valve.

Advantageous further developments of the invention are indicated in the subclaims.

All combinations of at least two features disclosed in the specification, claims and/or figures fall within the framework of the invention.

To avoid repetition, features disclosed with respect to the device are also to be regarded as disclosed and claimed for the method. In like manner, features disclosed with respect to the method are also to be regarded as disclosed and claimed for the device.

The invention is based on the idea of equipping the cooling medium valve with a hydraulic actuator, i.e., with a hydraulically actuatable (displaceable) adjustment element, the hydraulic displacement of which makes it possible to vary or set the volume flow ratio. It is now significant that no external or separate hydraulic medium is used for displacing the adjustment element, but rather the cooling medium itself. To this end, it is provided that the adjustment element can be supplied with cooling medium, in particular from the pressure side, of the cooling medium circuit for its displacement, and thus for setting the volume flow ratio, specifically by way or means of at least one control valve, which preferably, as has yet to be explained below, can be actuated by a control unit, wherein the actuation need at least not absolutely depend on the actual cooling medium temperature or an actual oil temperature of the engine. Rather, the cooling circuit arrangement according to the invention makes it possible to anticipatorily set the volume flow ratio, and thus the cooling medium temperature, for example before sharp ascents, for example which can be ascertained by means of a navigation device allocated to the control unit, and/or before descending sections. It is also possible to shift the desired value of the cooling medium temperature for various operating states via the control unit, for example by prescribing different desired temperature values for partial-load operation or full-load operation, or by also including the (non-engine-dependent) actual ambient temperature as a control parameter for setting the volume flow ratio. In addition, the cooling circuit arrangement according to the invention makes it possible to more accurately adjust or set the cooling medium temperature than could be done with an expansion element affected by tolerance and hysteresis, which as a rule is still used in practice.

Another essential advantage to applying a hydraulic actuator while using the cooling medium as the hydraulic medium for displacing the adjustment element is that the cooling medium, and thus the hydraulic medium, along with a pressure difference required for displacing the adjustment element, are already present in the immediate vicinity—the pressure difference is inevitably present when operating the conveyor pump in the cooling medium circuit between the suction and pressure side. A force difference necessary for displacement can also be easily set on the adjustment element by selecting a suitable ratio between the pressurized surfaces of the adjustment element, in particular when the adjustment element is not to be supplied with pressure-side cooling medium for its displacement, but rather with suction-side cooling medium, for example. It is important that the supply of cooling medium result in a displacement force on the adjustment element, which displaces the latter for setting the volume flow ratio, in particular against the spring force of a return spring. In addition, the seal for the cooling medium valve can be given a comparatively simple design, in particular in the area of the hydraulic actuator, since any acceptable or deliberately left leakage can only arise in the same medium (cooling medium). Very special emphasis must be placed on the advantage that the hydraulic actuator has a much simpler structural design by comparison to an electromagnetic actuator, which leads to fewer possible errors, lower costs and a low weight. The assembly space of the hydraulic actuator is also smaller by comparison to other actuators, for example a pneumatic actuator, and as mentioned above, fewer and/or lesser quality seals are required.

As has yet to be explained below, there are basically two different realizable embodiments of a cooling circuit arrangement according to the invention. In one simple variant in terms of structural design and control technology, the at least one control valve, which to this end is preferably designed as a discretely switching switch valve or as a proportional valve actuated as a switch valve, can be switched between two discrete or stable switch positions or end switch positions, wherein each switch position results in a discrete adjustment (element) position or setting, which has allocated to it a specific, in particular maximum or minimum volume flow ratio. All cooling media here preferably flow through the cooler fluid path in one of the switch positions, while in the other switch position at a prescribed ratio flow through both the cooler fluid path and through the bypass fluid path, or alternatively exclusively through the bypass fluid path. This simple realization approach eliminates the need for sensing the position of the adjustment element (since the position of the control valve need not be regulated), and the control element can be actuated via a (simple) thermal switch. In an alternative embodiment variant, it is possible, in particular by using a proportional valve that can be actuated in intermediate switch positions, to set several, in particular any intermediate positions of the adjustment element between its end positions, so that the volume flow ratio can be varied, in particular continuously or stepped, in a range of between 100% and 0%.

In an embodiment variant of the cooling circuit arrangement, it is especially expedient that the cooling medium valve be arranged in the suction-side area of the cooling medium circuit, and that a free flow cross section of a connection of an outlet of the cooler fluid path to the cooling medium pump and/or a free flow cross section of an outlet of the bypass fluid path to the cooling medium pump be variable by displacing the adjustment element, either directly by means of the adjustment element itself or by means of a valve body that can be actuated by or is coupled with the latter.

Therefore, in a further development of the invention, it is provided that the inflow of the [missing word] through the bypass fluid path and/or the cooler fluid path to the cooling medium pump suction side be set by hydraulically displacing the adjustment element. Alternatively, with the cooling medium valve with hydraulic actuator according to the invention correspondingly integrated in an area downstream from the engine before the inlets to the bypass fluid path and to the cooler fluid path, it is of course also possible to vary the volume flow through the bypass fluid path and/or cooler fluid path on the input side.

Especially preferred in terms of structural design is an embodiment of the cooling circuit arrangement in which the adjustment element indirectly or directly borders a control chamber that can be supplied with the preferably pressure-side cooling medium via the at least one control valve, wherein the adjustment element can be displaced in a first displacement direction by varying the pressure in the control chamber via the at least one control valve or via the quantity of preferably pressure-side cooling medium filling the control chamber. It makes sense that this displacement movement enlarge the cooling medium volume flow through the cooler fluid circuit. The side of the adjustment element facing away from the control chamber preferably borders a valve chamber also supplied or filled with cooling medium. This valve chamber is best joined with the suction side of the cooling medium circuit, preferably in a permanent, i.e., uninterruptible manner, so as to thus ensure the desired pressure difference for displacing the adjustment element without having to take any other additional measures. In particular such an embodiment variant enables the use of especially small control valves. However, it is basically also possible to provide pressure-side cooling medium in the valve chamber through a fluid-conducting connection to the pressure side, wherein the difference in force between the two sides of the adjustment element must in this case be prescribed by realizing a corresponding pressure surface ratio of the surfaces supplied with cooling medium on both sides of the adjustment element. This also holds true for the theoretically implementable case of supplying the control chamber with suction-side cooling medium, or a cooling medium under a lower pressure than the cooling medium in the valve chamber. In particular on the adjustment element, these pressure surfaces can in the especially preferred variant (control chamber connection on pressure side/valve chamber connection on suction side) advantageously be of the same size.

As an alternative to the embodiment variant described above, in which exclusively one of the chambers bordered by the adjustment element can be joined with the cooling medium circuit via the at least one control valve or a free flow cross section of the corresponding connection can be varied, another embodiment variant of the cooling circuit arrangement provides that both the control chamber and the valve chamber can be joined with the cooling circuit via the at least one control valve in order to displace the adjustment element, as a result of which both chambers, in particular with differing pressure levels, are then simultaneously linked to the cooling medium circuit via the control valve in a fluid-conducting manner, so as to exert a resultant hydraulic adjustment force on the adjustment element preferably directly bordering the two chambers, in particular with a pressure difference being set therein between the two chambers. This can preferably be realized by having one of the chambers be joined with the pressure side of the cooling circuit, and the other chamber with the suction side. Such an embodiment can basically be realized without a return spring for the adjustment element, which also represents a preferred embodiment variant. For displacement in the opposite direction, the chambers are then oppositely joined with the cooling medium circuit, so as to obtain a pressure difference between the chambers with opposite signs. Such an embodiment, in which the at least one control valve can be used to join both the control chamber and valve chamber for displacing the adjustment element with the cooling medium circuit or vary the flow cross section of a corresponding connection, enables a further development of the invention, in which the control chamber and valve chamber can be joined by means of the at least one control valve with the cooling circuit in such a way and/or the corresponding cross section of corresponding connections can be varied in such a way as to hold the adjustment element in a set position, in particular an intermediate position between the extreme set positions. This can preferably be achieved by having the control chamber and valve chamber be joined with the pressure side of the cooling circuit, or alternatively with the suction side of the cooling circuit.

Additionally or alternatively to a different pressure level in the control chamber and valve chamber, a hydraulic actuating force that acts on the adjustment element can be generated by providing various actuating force-exerting surfaces on the adjustment element, with which the adjustment element borders the two chambers.

As has yet to be explained in detail below, there are various possibilities with respect to the specific configuration of the at least one control valve. For example, it is basically possible to use one or several proportional valve(s) and/or one or several discretely switching switch valve(s) or slide valve(s). In other words, the cooling circuit arrangement can be realized with a single control valve or with several control valves, so as to realize a specific valve functionality, for example a 3/2-way valve functionality or a 4/3-way valve functionality. The use of one or several discretely switching switch valves among others is very especially preferred, since these are less sensitive to contamination of the cooling medium.

Regardless of whether the valve chamber is specifically supplied with suction-side or pressure-side cooling medium, it is advantageous that the adjustment element directly border these chambers and, depending on the adjustment element position and the resultant volume flow ratio, border different volumes (control chamber volume or valve chamber volume), since these are changed by the displacement of the adjustment element.

As characteristic for the embodiment variant described at the outset, the at least one control valve can be used to join only the control chamber with the cooling medium circuit and/or a free flow cross section of a corresponding connection can be varied, in particular reciprocally or alternatively with the pressure side or suction side of the cooling medium circuit. A return spring is preferably provided in the embodiment described above. In the alternative embodiment variant of the cooling circuit arrangement already alluded to beforehand, the at least one control valve can be used to join not only the control chamber, but rather, in particular simultaneously, the valve chamber with the cooling circuit, so as to generate a resultant hydraulic adjustment force on the adjustment element. As preferred, such an embodiment does without a return spring, wherein a return spring can still be provided anyway, if necessary or desired. However, a return spring is preferably omitted. In order to—in particular translationally—displace the adjustment element in a first displacement direction, which preferably increases the volume flow through the cooler fluid path, the at least one control valve comprised of one or several valves is used to join the control chamber with the pressure side of the cooling medium circuit and the valve chamber with the suction side of the cooling medium circuit and/or the free flow cross section of the respective connection is varied, in particular enlarged. In order to displace the adjustment element in a second displacement direction opposite the first displacement direction, which preferably results in an increase in the volume flow through the bypass fluid path, the at least one control valve is used to join the valve chamber with the pressure side of the cooling medium circuit and the control chamber with the suction side of the cooling medium circuit, or the free flow cross section of the respective connection is varied, in particular enlarged. It is important that the pressure conditions in the chambers be set by means of the control valve in such a way that the respective connection to the cooling medium circuit result in a supply of cooling medium to the respective chamber, such that a hydraulic displacement force acts on the adjustment element in the desired direction. Basically realizable as well is an embodiment in which displacing the adjustment element in a first displacement direction enlarges the volume flow through the bypass fluid path, and displacing the adjustment element in the second adjustment direction [word missing] the volume flow through the cooler fluid path, wherein the alternative allocation of the displacement direction and enlargement of the volume flow is preferred for reasons of a fail-safe design.

If necessary, the manufacture and/or variation of the flow cross sections of the fluid-conducting connections between the cooling medium circuit and control chamber as well as the valve chamber by means of the at least one control valve can be used to set a pressure ratio in the two chambers that results in no resultant displacement force on the adjustment element. In other words, correspondingly joining the two chambers with the cooling medium circuit via the at least one control valve makes it possible to keep the adjustment element in an adjustment position, in particular a (preferably whatever desired) intermediate position between two extreme adjustment positions, so as to preserve one of several possible volume flow ratios. To this end, the two chambers are especially preferably joined with the same side (same pressure level) of the cooling medium circuit. The two chambers are preferably connected with the suction side if the cooling medium valve will be or is arranged on the suction side of the cooling medium pump, and alternatively with the pressure side in the event that the cooling medium valve will be or is arranged on the pressure side of the cooling medium pump. As has yet to be described in detail below, the last described embodiment, in which the adjustment element is kept in one, in particular of several, intermediate positions by joining the control chamber and valve chamber with the cooling medium circuit, is not necessary for realizing this functionality, although a proportional valve can be used as an alternative. This functionality can be realized with one or several discretely switching (not proportional) valve(s), in particular by using a 4/3-way valve functionality.

In an especially preferred embodiment variant of the cooling circuit arrangement, the adjustment element can be translationally displaced, wherein a twistable or rotatable embodiment can alternatively also be realized. However, in order to displace the adjustment element in a first (translational or rotary) displacement direction, it is preferable that the at least one control valve can be used to join the control chamber with the cooling medium circuit, preferably with the pressure side of the cooling medium circuit, and/or a free flow cross section of a connection between the cooling medium circuit, preferably the pressure side of the cooling medium circuit, and the control chamber can be enlarged, and that, in order to displace the adjustment element in a second displacement direction opposite the first displacement direction by means of the control valve, a connection between the control chamber and the cooling medium circuit, preferably the suction side (low pressure side) of the cooling medium circuit, in particular a suction side chamber, preferably the aforementioned valve chamber or a wide chamber inside of the cooling medium valve connected with the latter in a fluid-conducting manner can be opened and/or a free flow cross section of this connection can be enlarged. A control valve that can be operated as a proportional valve is ideally used for establishing the aforementioned connections and/or for changing their flow cross section. In this way, the use of a single control valve is sufficient for realizing both functions. However, it is basically also possible to divide the functions among several valves. It is especially expedient that the adjustment element be continuously displaceable, for which it makes sense to use at least one proportionally operable control valve. However, a stepped displaceability can also be realized, either by correspondingly actuating a proportionally actuatable valve or providing a valve cascade of discretely switching switch valves. In the preferred embodiment described above, a corresponding proportional (constant) actuation of the control valve, in particular through PWM energizing, makes it possible to start up a plurality of adjustment positions with the adjustment element, i.e., in particular a plurality of intermediate positions between two extreme or end adjustment positions, so as thereby not to allow only all of the cooling medium to flow either through the cooling path or alternatively through the bypass fluid path, but preferably also to be able to set several intermediate values or intermediate volume flow ratios (as well) apart from these extreme volume flow ratios. However, within the framework of an alternative, structurally simple and/or cost-effective embodiment that is robust when it comes to contaminants in the cooling medium, it is alternatively possible to use at least one discretely switching, preferably bistable switch valve as the control valve in place of a proportional valve, or to actuate a proportional valve as a switch valve, so that only two extreme positions can be set with the adjustment element, which each are defined by a predefined volume flow ratio. This makes it possible to use a simple control unit, in particular comprising a thermal switch, which energizes or precisely does not energize the control valve as a function of a temperature, for example of the cooling medium or engine oil, so as to thereby set one of the two switching states. In one position of the adjustment element or switching position of the control valve, the entire cooling medium volume flow preferably flows over the cooler path, while the entire cooling medium volume flow flows over the bypass fluid path in the alternative switching position, wherein alternative volume flow ratios can also be prescribed in the two positions of the adjustment element.

It also is especially expedient from a structural standpoint that the control chamber and valve chamber be arranged inside of a cylinder of the cooling medium valve, which envelops the adjustment element that is preferably piston-shaped and translationally displaceable. Possible leakage between the control chamber and valve chamber, in particular radially outside on the adjustment element through a gap between the adjustment element and cylinder, is acceptable.

As a consequence, a further development of the invention provides that a leakage fluid path be realized between the control chamber and valve chamber (independently of the specific configuration and arrangement) (for example, between the outer circumference of the adjustment element and the inner circumference of a cylinder enveloping the latter), through which a cooling medium leakage volume flow can flow out of the control chamber and into the valve chamber. In the event that cost reasons dictate that larger component tolerances are to be accepted and/or the use of elastomer seals is to be eliminated or their use is to be minimized, it is possible to deliberately have the plans include such a leakage fluid path in the design process.

As mentioned, there are various options with respect to the specific configuration of the at least one control valve. It especially makes sense for it to be a proportional valve, wherein the proportionality can also be achieved by a PWM (pulse width modulated) actuation in a known manner, for example, in that the corresponding actuation can set an average, free flow cross section of a desired connection. However, it is also possible to provide in particular several discretely switching valves for realizing the functions of the cooling medium valve. It is also conceivable to use several proportionally operable or operated, in particular solenoid, valves.

It is very especially preferable that the at least one control valve for realizing the embodiment, in which both the control chamber and valve chamber can be joined with the cooling medium circuit by means of the at least one control valve, the at least one control valve have a 4/3 way functionality. For example, this can be realized by connecting in series two 3/2 way valves each provided with an actuator or directly by means of a 4/3 way valve, for example a proportional valve. However, very especially preferred is an embodiment of the at least one control valve as a multi-seat switch valve, in particular as a 4/3 way valve, which comprises two valve bodies displaceable with a shared actuator, wherein one of the valve bodies can be displaced through the other valve body by means of the shared actuator, which is realizable by having one of the valve bodies be penetrated by an adjusting part, which in turn can be displaced, in particular shifted, by means of a shared actuator. In other words, a discretely switching multi-seat switch valve can be realized in this way, wherein the two valve bodies each are arranged so as to be discretely displaceable between two valve seats, in order to alternatively connect a respective working port with the suction side or pressure side of the cooling medium circuit—the 4/3 way valve functionality is then not realized with a classic slide valve solution in this embodiment, but rather in the form of a multi-seat switch valve (that is robust against contaminants), in which two valve bodies are displaceably arranged between a respective two discrete adjustment positions or valve seats, so as to implement the 4/3 valve path functionality.

As an alternative to the embodiment described above, in which two (switch) valves are allocated to each valve body, an alternative embodiment variant of the at least one control valve can be realized as a combined slide-multi-seat-switch valve. Such an embodiment preferably makes do with only two return springs, wherein one of the valve bodies, in particular the valve body closer to the shared actuator, can further be displaced between two (switch) valve seats, while the other valve body can preferably also be displaced between two stops, but only one of them has to be designed as a switch valve seat, while another valve seat functionality is assumed by an adjusting part that is integrally designed with the other valve body, and axially penetrates the valve body mentioned first. This adjusting part is preferably provided with an axial through bore, as well as with at least one radial bore, which takes over or can take over a valve slide functionality by interacting with a circumferential wall of a guiding channel for the adjusting part.

In the preferred case of using at least one solenoid control valve, it makes sense to realize a fail-safe functionality, i.e., to ensure that the cooler fluid path is preferably maximally open given a de-energized control valve. When not energizing the control valve, it is to this end preferred that a fluid connection be preferably maximally opened between the pressure side of the cooling medium circuit and the adjustment element or the control chamber indirectly or directly bordered by the latter, so that the cooling medium pressure difference between the control chamber and valve chamber displaces the adjustment element in the first displacement direction, in particular until it reaches an end position, preferably a stop position.

The at least one control valve in particular designed or operated as a proportional valve is preferably configured and arranged in such a way that in particular its pressure side cooling medium feed and its return into the cooling fluid circuit, in particular to its suction side, preferably toward the valve chamber or a cooling medium valve chamber that is or can be connected with the latter, is adjusted, preferably current or voltage controlled, via a proportional position, preferably implemented by a corresponding PWM actuation.

The exemplary embodiments described above relate to a preferred embodiment variant for realizing a plurality of intermediate volume flow ratios between a completely open cooler fluid path and a completely closed cooler fluid path. In an alternative variant that is simpler in terms of control techniques, a discretely switching switch valve can also be used as the control valve, or a proportional valve can be actuated as the control valve, so that the control valve can be activated via a thermal switch, so as to displace the adjustment element between two predefined positions, in particular two extreme positions, which are characterized in particular by the fact that the cooler fluid path is completely open and/or the bypass fluid path is completely closed in a first position, and the cooler fluid path is completely closed and/or the bypass fluid path is completely open in another position.

In order to realize an inflow and outflow function for the cooling medium to the control chamber or away from the control chamber, it is advantageous overall to use a control valve, in particular a single control valve, that is designed as a 3/2 way valve.

As already indicated, in order to realize the embodiment in which the at least one control valve can be used to connect both the control chamber and valve chamber, in particular simultaneously, with the cooling medium circuit, or the flow cross section of corresponding connections can be varied by means of the control valve, it is preferred that the at least one control valve, which alternatively can consist of a single valve or several individual valves, have a 4/3-way valve function, wherein the at least one control valve has a preferably pressure side cooling medium pressure port and a preferably suction side cooling medium outflow port, along with two working connections, specifically a first working port, with which the cooling medium pressure connection and cooling medium outflow connection can be (alternatingly) joined with the control chamber or the flow cross section of a corresponding connection can be varied, and a second working port, with which the valve chamber can be joined with the cooling medium pressure port and cooling medium outflow port, or the flow cross section of a corresponding connection can be varied. This 4/3-way valve functionality is very especially preferably implemented with a control valve which, as already explained beforehand, has a single, preferably solenoid, actuator, with which two valve bodies scan be displaced in particular between a respective two valve seats, wherein one of the valve bodies is penetrated by an adjusting part that can be displaced by means of the actuator. The cooling medium pressure port or alternatively the cooling medium of the outflow port preferably can have joined to it the first working port to the control chamber by one of the valve bodies, and the second working port to the valve chamber by the other valve body.

The valve bodies are here arranged by means of the actuator so as be displaceable preferably against the restoring force of a respective return spring, wherein the return springs are preferably configured so that the valve bodies can be displaced one after the other. It is very especially preferred that an additional spring be provided between the valve body penetrated by the adjusting part and the actuator, wherein this spring is preferably penetrated by the adjusting part. This spring provides path compensation given an already displaced, adjacent valve body, and further displaces the adjusting part for displacing the valve body spaced further apart.

An alternative construction of the at least one control valve makes do with exclusively two return springs. Even this type of combined slide-multi-seat switch valve consists of the aforementioned first and second working port along with a cooling medium pressure port and a cooling medium outflow port. One of the valve bodies is also penetrated by an adjusting part. However, the adjusting part cannot be displaced relative to the two valve bodies as in the previously described embodiment, but rather only relative to a valve body penetrated by the adjusting part, in particular the valve body arranged closer to the shared actuator, while the adjusting part is fixedly joined with the other valve body or monolithically designed with the latter. In such an embodiment variant, the valve body not fixedly joined with the adjusting part is preferably axially entrained from the adjusting part while displacing the adjusting part by means of the actuator, in particular after a valve slide seat realized by the adjusting part was closed by displacing the adjusting part, wherein a connection between the first working port and cooling medium outflow port is preferably closed by sealing this slide valve seat. As a consequence, the adjusting part has a valve slide or valve body function in the combined slide-multi-seat valve seat solution. At the same time, an axial through channel formed in the adjusting part joins the cooling medium outflow port or alternatively the cooling medium pressure port with a control valve chamber, which by displacing the valve body penetrated by the adjusting part can be joined with the working port or fluidically separated from the latter, so that displacing the valve body penetrated by the adjusting part makes it possible to establish or interrupt a fluid-conducting connection between the second working port and the control valve port coupled in a fluid-conducting manner via the adjusting part (pressure port or outflow port).

Depending on the control valve configuration and/or actuation, it is possible and preferred that a valve body of the control valve be used to initiate or set an intermediate position or intermediate setting, such that a part of the cooling medium flowing in from the pressure side is directly diverted or discharged before reaching the control chamber toward the suction side of the cooling medium circuit, wherein it especially makes sense that discharging toward the valve chamber take place inside of the cooling medium valve or in another chamber of the cooling medium valve joined with the valve chamber in a fluid-conducting manner.

It is very especially preferred that the cooling medium valve and the at least one, preferably only, control valve be realized as a shared assembly, in which the control valve is arranged on a housing of the cooling medium valve, and in particular fixed in place therein. This embodiment makes it possible to realize a removal line for discharging cooling medium from the control chamber via the control valve as the channel inside of the housing, i.e., in the housing material of the cooler medium pump and/or a connecting line between the control valve and the control chamber as a channel in the cooling pump housing.

As mentioned at the outset, it is preferred that the in particular solenoid control valve have allocated to it a control unit (control means), which is joined with an actuation of the control valve for setting the volume flow ratio of the cooling medium flows, and hence the cooling medium temperature. Depending on the configuration, this actuation can take place as a function of an engine-dependent temperature signal, which preferably is measured by means of a temperature sensor. To this end, for example, the cooling medium temperature or some other nominal engine temperature can be drawn upon, for example an engine oil temperature. It especially makes sense that the control valve be actuated independently of the temperature signal in at least one operating state, wherein independently of the temperature signal here means temperatures that are related to the engine temperature. In such an operating state, it is basically also possible to actuate the control valve by means of the control unit as a function of the ambient temperature (outside temperature) and/or as a function of an operating state of the engine and/or as a function of an expected terrain and/or road course (in particular descents and/or ascents).

In order to eliminate the influence of pressure fluctuations in the cooling medium circuit on the actuation or regulation of the control valve, it is preferred that the control unit, so as to determine an actual volume flow ratio as the control parameter, be joined in a signal-conducting manner with a position sensor with which the position of the adjustment element can be detected, since the volume flow ratio is directly dependent on the specific displacement position of the adjustment element. For example, this type of position detection is possible through the use of a Hall sensor.

It is advantageous overall if the adjustment element, when supplied with cooling medium on the pressure side, can be displaced in the first displacement direction against the spring force of a return spring (in particular simultaneously accompanied by an enlargement of the control chamber). Given a corresponding control valve position, the optional return spring ensures the return displacement of the adjustment element. In an embodiment variant without a return spring, both the control chamber and valve chamber can be joined with the cooling medium circuit via the at least one control valve.

As already alluded to at the outset, it is advantageous overall that the cooling medium valve be arranged on the suction side of the cooling medium pump, wherein the cooling medium pump is preferably arranged in such a way that the cooling medium flows out of the pump and to the engine, and that the cooling circuit downstream from the engine be divided into the bypass fluid path and cooler fluid path.

The invention also presents a method for cooling an engine, in particular a motor vehicle combustion engine, preferably with the use of a cooling circuit arrangement according to the invention. The invention provides that an actuator of the used cooling medium valve have a hydraulically displaceable adjustment element, which is supplied with cooling medium from the cooling medium circuit, in particular from the pressure side, for its displacement and the resultant setting of the volume flow ratio via a control valve allocated to the cooling medium valve.

In a possible embodiment variant, the adjustment element is displaced in a first displacement direction, in which exclusively the control chamber is joined with the cooling medium circuit by means of the at least one control valve and/or the flow cross section of a corresponding connection is varied. The return displacement then preferably takes place in a displacement direction opposite the first displacement direction by means of a return spring, which very especially preferably is arranged in the valve chamber. The valve chamber is permanently (preferably not via the control valve element) joined with the cooling medium circuit, in particular with its suction side. In an alternative embodiment variant, the adjustment element is displaced in the first displacement direction by having the at least one control valve join both the control chamber and valve chamber with the cooling medium circuit in a respectively fluid-conducting manner and/or varying the flow cross section of a corresponding connection. It is preferred that the control chamber be joined with the pressure side and the valve chamber with the suction side of the cooling medium circuit or vice versa in order to displace the adjustment element in the first displacement direction, and that the valve chamber be joined with the pressure side and the control chamber with the suction side or vice versa for purposes of displacement in the second displacement direction opposite the first displacement direction.

### BRIEF DESCRIPTION OF THE DRAWINGS

Additional advantages, features and details of the invention may be derived from the following description of preferred exemplary embodiments, as well as based on the drawings.

The latter show:

FIG. 1: A cooling medium circuit arrangement designed based on the inventive concept, with completely open cooler fluid path (large circuit) and completely closed bypass fluid path (small circuit), wherein the control valve designed as a solenoid valve is in its de-energized state,

FIG. 2: A cooling medium circuit arrangement according to FIG. 1 with completely open bypass fluid path and completely closed cooler fluid path, as well as maximally supplied control valve,

FIG. 3: A perspective sectional view of a preferred embodiment of a cooling medium valve that is preferably used in the cooling circuit arrangement according to FIGS. 1 to 3, and has a control valve designed as a 3/2 path proportional solenoid valve, which either accompanies or forms a structural unit with it,

FIG. 4: A hydraulic equivalent circuit diagram of an alternative embodiment of a cooling circuit arrangement according to the invention, in which the at least one control valve joins the control chamber and valve chamber with the pressure side and suction side of the cooling medium circuit in a simultaneously alternating manner,

FIGS. 5 to 7: Different valve positions of a multi-seat switch valve with a 4/3-way functionality that is preferably used in a cooling circuit arrangement according to FIG. 4,

FIG. 8: A diagram [showing] the spring force progressions for the springs used in the control valve depicted on FIGS. 5 to 7,

FIGS. 9 to 11: Different valve positions of an alternative combined slide-multi-seat switch valve with a 4/3-way functionality that is preferably used for hydraulically displacing a cooling medium valve in a cooling medium circuit, FIG. 12: A diagram [showing] the spring force progressions for the springs used in the control valve depicted on FIGS. 9 to 11.

Identical elements and elements with the same function are marked with the same reference number on the figures.

### DET_{A} ILED DESCRIPTION

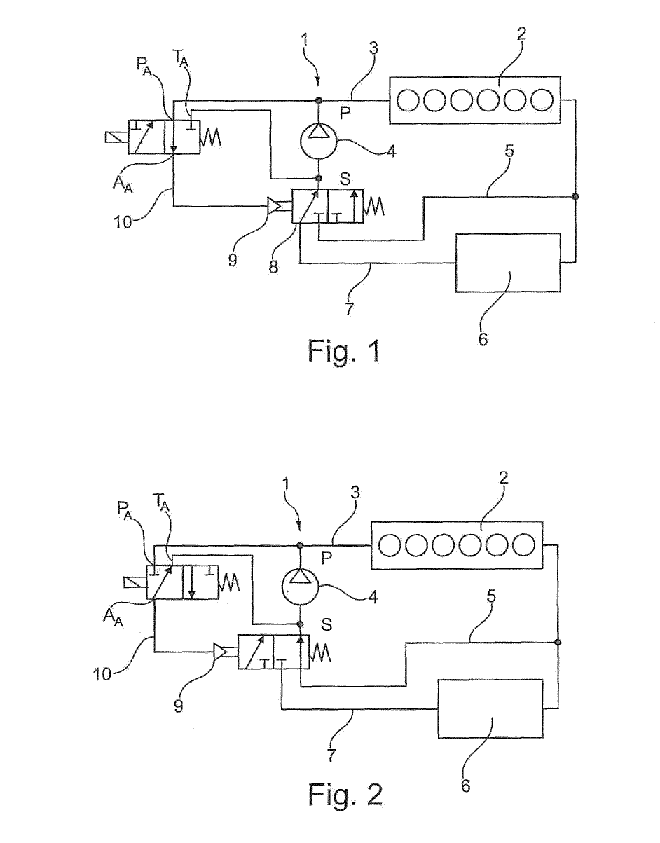

FIG. 1 shows a cooling circuit arrangement 1 designed based on the inventive concept, in particular for integration into a motor vehicle (mv).

In evidence is an engine 2 to be cooled, here exemplarily designed as a combustion engine, which is integrated into a cooling medium circuit 3 or hooked up thereto in a known manner. This cooling medium circuit 3 consists of a cooling medium pump 4 preferably driven by the engine 2 that conveys cooling medium from a suction side S of the cooling medium circuit 3 to a pressure side P.

After the engine 2, the cooling circuit 3 branches into a bypass fluid path 5, which in the specific exemplary embodiment completely bypasses a cooler 6 (radiator), and a cooler fluid path 7 that flows through the cooler 6.

Both the bypass fluid path 5 and cooler fluid path 7 are guided to a cooling medium valve 8, which can be used to set the volume flow ratio of the cooling medium volume flows flowing through the fluid paths 5, 7. In an alternative embodiment (not shown), the cooling medium valve 8 after the engine can be arranged where the cooling medium circuit 3 branches into the bypass fluid path 5 and cooler fluid path 7, and set the inflow in at least one of these paths. It is basically possible to use a cooling medium valve 8 to only set or influence the free flow cross section of one of the fluid paths 5, 7, wherein it makes more sense to vary both flow cross sections, in particular simultaneously or coupled, by actuating the cooling medium valve. Regardless of the specific configuration and arrangement of the cooling medium valve 8, the latter in any event has a hydraulic actuator 9 with a hydraulically activatable adjustment element. The adjustment element can be displaced through exposure to hydraulic pressure by means of a pressure-side cooling medium. To this end, the actuator 9 can be supplied with the aforementioned pressure-side cooling medium via a connecting line 10 by means of a control valve 11 presently designed as a solenoid 3/2-way proportional valve.

For this purpose, the control valve 11 comprises a pressure port P_{A}, which is hooked up to the pressure side P of the cooling circuit 3. The control valve 11 further comprises a working port AA, by way of which pressure-side cooling medium is guided to the adjustment element (also as a function of the valve position). The control valve 11 further comprises a outflow port T_{A}, by way of which cooling medium can be diverted or discharged from the adjustment element or a control chamber allocated thereto and/or the pressure port PA to the suction side S of the cooling circuit 3.

The control valve 11 is designed in such a way that the connection between the ports P_{A} and A_{A} in the depicted non-energized position is completely open. To this end, a valve spring of the control valve 11 correspondingly displaces the valve body of the control valve 11 against a stop.

As evident, a connection established via the cooling medium valve 8 between an outlet of the cooler fluid path 7 and the cooling medium pump 4 is completely open, while the outlet of the bypass fluid path 5, and hence its suction side, is completely closed, so that the cooling medium pump conveys the entire cooling medium flow through the cooler 6.

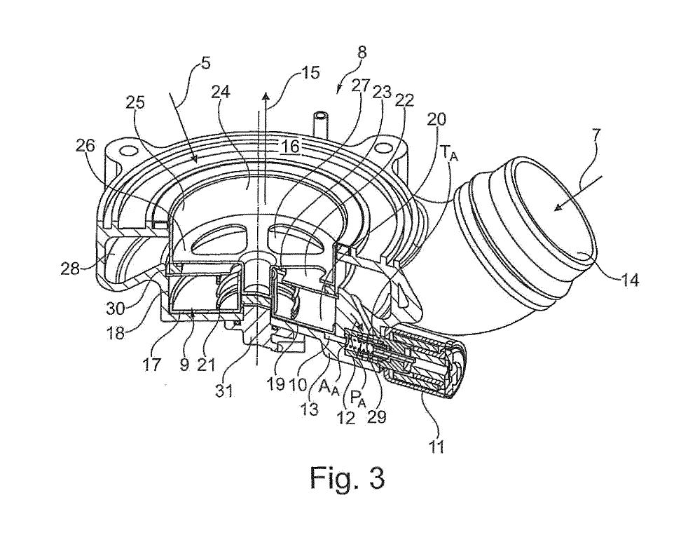

FIG. 2 shows the other extreme case. Correspondingly actuating the control valve 11 here interrupts the pressure-side cooling medium supply to the actuator 9, and the actuator 9, or more precisely the control chamber provided therein and allocated to the adjustment element, is hydraulically connected with the outflow port T_{A}, so that cooling medium located in the control chamber can be discharged to the suction side S, and the adjustment element is displaced by the valve springs (return springs) of the cooling medium valve 8 into the shown position, in which the cooling medium valve 8 completely closes off the cooler fluid path 7, and instead completely opens the outlet of the bypass fluid path 5 or connects it with the cooling medium pump 4.

Correspondingly actuating the control valve 11 also makes it possible to set in particular any intermediate positions, so that both the cooler fluid path 7 and the bypass fluid path 5 are partially open toward the cooling medium fluid pump 4.

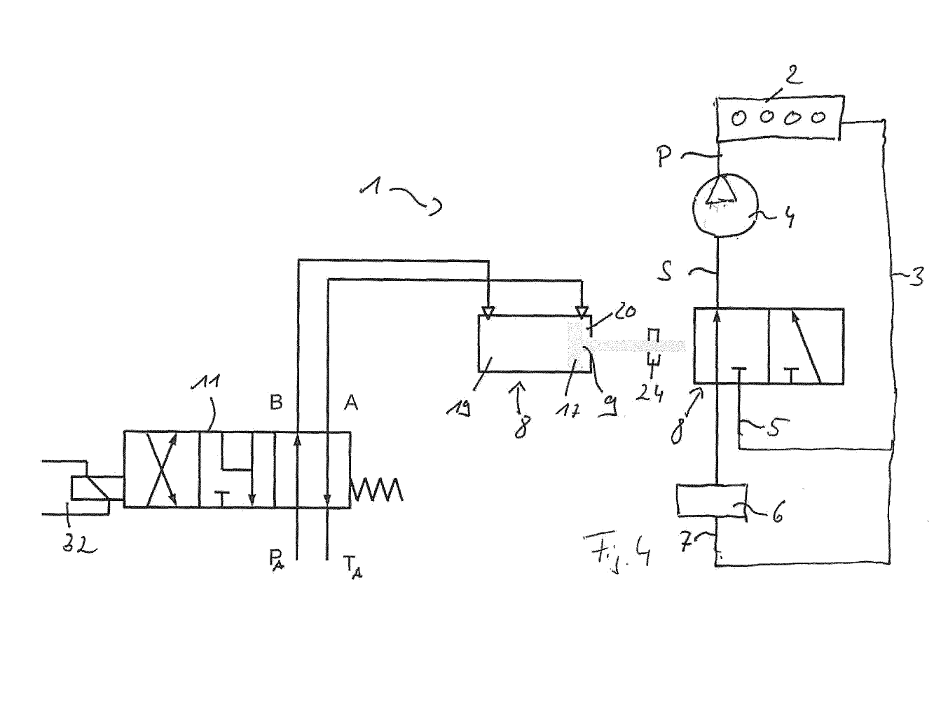

FIG. 3 presents a perspective, cut view of a preferred embodiment of a cooling medium 8 according to the invention, in particular for integration into a cooling circuit arrangement 1 shown on FIGS. 1 and 2.

The cooling medium valve 2 together with the control valve 11 forms a shared assembly, for which purpose the control valve 11 is secured to the cooling medium valve 8 and, for example, here protrudes axially into an outwardly open port opening 12 in a housing 13 of the cooling medium valve 8.

The housing 13 of the cooling medium valve comprises an inlet 14 for the cooling medium flow from the cooler fluid path 7. A likewise provided inlet for the fluid flow from the bypass fluid path 5 is not depicted. This fluid flow gets into the area marked with the arrow 5. The cooling medium valve 8 comprises a (shared) outlet 15 denoted only by an arrow for cooling medium from the bypass fluid path and cooler fluid path, wherein the volume flow ratio for these volume flows can be set by means of the cooling medium valve. Depending on the switched position of the cooling medium valve 8, the outlet 15 joins the fluid paths with the cooling medium pump 4 (see FIGS. 1 and 2).

The cooling medium pump 8 comprises a hydraulic actuator 9 with a here translationally displaceable adjustment element 17, which is arranged as a piston in a cylinder 18 formed by the housing 13. The adjustment element 17 separates a control chamber 19 formed in the housing 13 from a valve chamber 20 arranged on the side of the adjustment element 17 facing away from the control chamber, which is connected with the outlet 15 in a directly fluid-conducting manner.

A return spring 21 exerts a spring force on the adjustment element 17 in a second, lowermost displacement direction in the drawing plane, so that the adjustment element 19 tries to minimize the volume of the control chamber 17.

The return spring 21 is axially supported directly on the adjustment element 17 at one end, and at the other end on a reciprocal support plate 22, which has a through opening 23 for joining the valve chamber 20 in a fluid-conducting manner with the suction side of the outlet 15 connected with the suction side of the cooling medium circuit.

An annular slide 24 is secured to the adjustment element 17, so that displacing the adjustment element simultaneously also displaces the annular slide 24, so that, as has yet to be explained below, the volume flow ratio released to the cooling medium pump 4 can be set between the bypass fluid path volume flow and cooler path volume flow.

The annular slide 24 has a cylindrical shell surface section 25 along with a floor section 26 oriented perpendicular thereto, wherein the latter once again is provided with openings 27, so as to join the valve chamber 20 with the outlet 15 in a directly fluid-conducting manner.

In order to displace the adjustment element 17 in a first displacement direction, i.e., upwardly in the drawing plane, the control chamber 19 has to be supplied with cooling medium from the pressure side of the cooling medium circuit 3 (see FIGS. 1 and 2). This is realized via the control valve 11 here exemplarily designed as a solenoid 3/2-way valve. To this end, the latter has the pressure port PA denoted by an arrow, by way of which the pressure-side cooling medium can flow in. The inflow takes place from the pressure port PA via the working port A_{A} of the control element 11 as well as the connecting line 10 designed as a bore or channel in the housing 13. Depending on the valve position, cooling medium from the control chamber 19 can again be discharged via the connecting line 10, specifically by way of the outflow port T_{A} of the control valve 11 and the connecting channel 29 (diverting line) in a chamber 28 designed as an annular chamber inside of the housing 13. On the other hand, the cooling medium volume flow from the cooler fluid path flowing in by way of the inlet 14 also flows in the chamber 28. By discharging cooling medium from the control chamber 19 into the suction-side chamber 28 that can be joined with the outlet 15 in a fluid-conducting manner, the pressure in the control chamber 19 can be reduced, so that the adjustment element 17 is displaced via the return spring 21 in the second displacement direction, i.e., downwardly in the drawing plane, which in turn results in a displacement movement of the annular slide 24.

In the depicted, preferred embodiment variant, because the control chamber 19 can be supplied with cooling medium from the pressure side P of the cooling medium circuit via the control valve 11 for displacing the adjustment element 17 in the first displacement direction, and the valve chamber 20 lies at suction pressure or on the suction side of the cooling medium circuit 3, the pressure-exposed surface of the adjustment element in the control chamber 19 and the pressure-exposed surface of the adjustment element in the valve chamber 20 facing away from the latter are equally large, as is preferred. If the control chamber 19 is supplied with cooling medium lying at another pressure level and/or the valve chamber 20 is secured to the cooling circuit at another location, the setting force necessary for displacing the adjustment element 17 can be generated by realizing pressure-exposed surfaces of varying size.

As evident from FIG. 3, the control valve 11 or its [missing word] communicates with the control chamber 19 via a connecting channel 29 inside of the housing 13.

If the cooling capacity is now to be increased, the control valve 11 is actuated in such a way as to open a fluid connection between the inlet 14 (outlet of the cooler fluid path) and the cooling medium pump or (even wider) the outlet (15). This is done by the control valve 11 assuming a valve position upon its actuation, which ensures that the pressure-side cooling medium waiting at the pressure port PA can flow through the control valve 11 and via the working port AA into the connecting channel 29 and by way of the latter into the control chamber 19. The pressure in the control chamber 19 rises, so that the adjustment element 17 is activated upwardly in the drawing plane in a first displacement direction. As a result, the annular slide 24 is also moved downwardly in the drawing plane, and the distance between the annular slide 24 and a housing-side control edge 30 increases, so that the free flow cross section enlarges a connection between the chamber 28 and outlet 15, ensuring that the cooling medium pump 4 can siphon more cooling medium per unit of time out of the cooler fluid path 7 either now or depending on the previous position, i.e., the large cooling circuit is opened (further).

A cooling medium leakage from the control chamber 19 by the adjustment element 17 and to the valve chamber 20 is acceptable.

In the specific exemplary embodiment, enlarging the aforementioned free flow cross section between the cooler fluid path 7 and cooler medium pump, in particular between the chamber 28 and outlet 15, diminishes a free cross section between the outlet 15 and bypass fluid path (not marked). This is specifically resolved by displacing the annular slide 24 (or an alternative final control element) in the first displacement direction so as to reduce the free cross section out of a chamber 16 supplied via the bypass fluid path 5 and the outlet, in particular to the same extent as the free flow cross section between the chamber 28 and outlet 15 is enlarged.

In order to reduce the cooling capacity, cooling medium is diverted out of the control chamber 19 via the connecting channel 29 and the control valve 11 via the connecting line 10 into the cooling medium circuit, specifically into the chamber 28 of the cooling medium valve 8. FIG. 3 denotes the location of a position sensor marked 31, which is used to detect the position of the adjustment element 17 for preparation as the input signal for regulating the volume flow ratio or cooling medium temperature by means of a control unit (not shown).

In an embodiment variant not shown in detail with a discretely switching switch valve as the control valve, the latter is preferably activated by way of a thermal switch, wherein the actuator array for displacing the adjustment element 17 can remain unchanged. This alternative embodiment eliminates the need for a position sensor for detecting the position of the adjustment element.

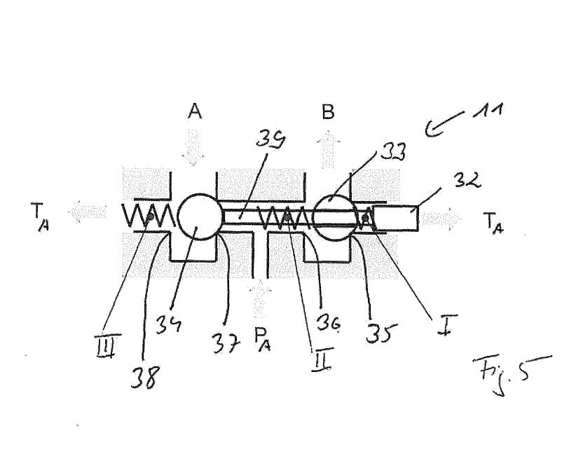

FIG. 4 presents an alternative embodiment of a cooling circuit arrangement 1 designed based on the inventive concept, in particular for integration into a motor vehicle (MV).

In evidence is an engine 2 to be cooled, for example here designed as a combustion engine, which is integrated in a known manner into a cooling medium circuit 3. This cooling medium circuit 3 consists of a cooling medium pump 4 that is preferably driven by the engine, and conveys cooling medium from a suction side S of the cooling medium circuit 3 to a pressure side P.

After the engine, the cooling circuit branches into a bypass fluid path 5, which in the specific exemplary embodiment completely bypasses a cooler 6 (radiator), and a cooler fluid path 7 that flows through the cooler 6.

Both the bypass fluid path 5 and cooler fluid path 7 are routed to a cooling medium valve 8, which is shown as an equivalent circuit diagram on the right of the illustration, and once again in terms of structural design in the middle area of the drawing, so that the adjustment element 17 and the annular slide 24 (or an alternative final control element) displaceable by it for pressure flow variation can be discerned by the cooler fluid path and bypass fluid path. The cooling medium valve 8 can be used to set the volume flow ratio of the cooling medium volume flows flowing through the fluid paths 5, 7. In an alternative embodiment variant (not shown), the cooling medium valve can also be incorporated after the engine where the cooling medium circuit 3 branches into the bypass fluid path 5 and cooler fluid path 7, and set the inflow in at least one of these paths.

The cooling medium valve consists of a control valve 11, which is designed as a 4/3-way valve in the specific exemplary embodiment. This 4/3-way functionality can be realized by using a corresponding proportional valve, or alternatively by wiring two discretely switching valves, in particular two 3/2-way switch valves or also proportional valves. An embodiment as a multi-seat valve yet to be explained below is especially preferred, in which two valve bodies can be activated with a shared actuator.

In any event, the control valve 11 consists of a pressure port P_{A}, which is hooked up to the pressure side P of the cooling circuit 3. The control valve further consists of a first working port B and a second working port A, as well as an outflow port T_{A}, by way of which cooling medium can be diverted to the suction side S of the cooling circuit 3. As evident, the first working port B is joined in a fluid-conducting manner with the control chamber 19 of the cooling medium valve 8, which is bordered from one side of the adjustment element 17, while the second working port A is joined in a fluid-conducting manner with the valve chamber 20, which is bordered by the side of the adjustment element 17 facing away from the control chamber 19, so that the adjustment element 17 can as a result be driven like a dual-action piston cylinder drive. To this end, the adjustment element 17 is incorporated in a cylinder. Similarly to the exemplary embodiment according to FIG. 3, an annular slide 24 (mentioned above) can be displaced via the adjustment element 17, so as to thereby set the volume flow ratio between the cooling medium volume flows flowing between the bypass fluid path 5 and the cooler fluid path 7. The cooling medium valve 8 is shown twice on FIG. 4 to illustrate its function and/or structural design (even though only present once, of course), specifically the structural configuration as a piston-cylinder regulator on the left of the illustration, and as a hydraulic equivalent circuit diagram integrated into the cooling medium circuit on the right of the drawing plane.

The left half of the drawing on FIG. 4 depicts various switching states of the control valve 11, three in the specific exemplary embodiment. The currently switched, right switching state joins the first working port B with the pressure port P_{A}, and hence with the pressure side P of the cooling circuit, causing pressure-side cooling medium to flow into the control chamber 19. At the same time, the second working port A is joined with the outflow port T_{A}, so that cooling medium can be discharged from the valve chamber 20 via the outflow port T_{A} to the suction side S of the cooling medium circuit. As a consequence, the adjustment element 17, and hence the annular slide 24 as well, moves to the right in the drawing plane in a first translational displacement direction in the depicted displacement position. The large coolant circuit shown on the right of the drawing plane is switched into the latter by means of the annular slide 24, so that all of the cooling medium flows over the cooling fluid path 7, and the bypass fluid path 5 is blocked.

In the switching position on the left side of the drawing plane, the control chamber 19 is joined with the suction side and the valve chamber 20 with the pressure side P of the cooling medium circuit, so that the adjustment element 17 is displaced to the left in the drawing plane in a second displacement direction, wherein, in the specific exemplary embodiment, all cooling medium flows through the bypass fluid path and completely circumvents the cooler 6 in the then resulting extreme switching position of the adjustment element, and hence of the annular slide 26. The control valve 11 is designed in such a way that, given a failure in energizing the valve actuator 32, here a solenoid actuator, the switching state of the control valve 11 described first and marked on FIG. 4 arises, thereby ensuring a fail-safe functionality in which the entire cooling medium volume flow flows over the cooler 6.

The control valve 11 can also be used to set another, here a middle switching position, in which both working ports B, A are joined with the outflow port T_{A} of the control valve 11, and hence with the suction side S. As a result, the respective current position of the adjustment element, which if necessary can be detected via a path or position sensor, is kept, so that basically any intermediate position of intermediate volume flow ratios can be kept.

The left switching position of the control valve 11 includes the right switching position of the cooling medium valve or of its annular slide 24 (very basically, it is of course also possible, depending on the configuration of the cooling medium valve, to use final control elements other than an annular slide to switch the fluid flow in the cooling circuit).

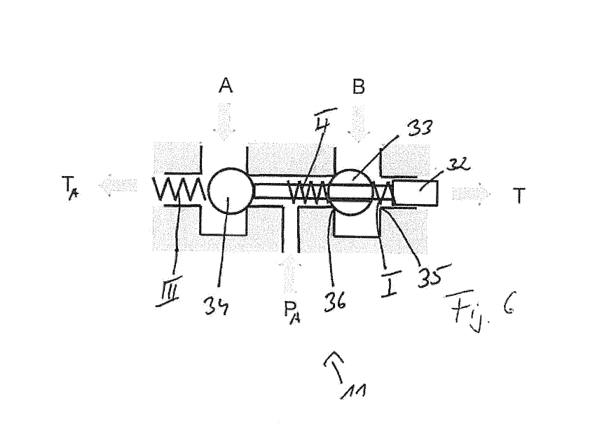

FIGS. 5 to 7 show a preferred embodiment variant for a preferably used control valve 11 with 4/3-way functionality. The control valve 11 can be activated with a single control valve actuator 32, and consists of two valve bodies, specifically a first valve body 33 and a second valve body 34, which each can be displaced between two switching positions or valve seats 35, 36, 37, 38 by means of the valve actuator 32.

Located between the valve actuator 32 and first valve body 33 is a first spring I, which is supported at one end against the first valve body 33. The first spring I along with the first valve body 33 are penetrated by a rod- or piston-shaped adjusting part 39, which can be translationally displaced by the actuator 32. The adjusting part 39 is supported against the second valve body 34 in order to displace it, and penetrates a second spring II that impinges on the first valve body 33 on the drawing plane toward the right, against the valve seat 35. To this end, the second spring II is supported against a thrust bearing (not shown) penetrated by the adjusting part 39. The third valve body 34 is also impinged to the right in the drawing plane, specifically against the valve seat 37 by a third spring.

The control valve 11 consists of a pressure port PA and an outflow port T_{A}, along with a first and second working port B, A, which are joined with the control chamber or valve chamber, as described in conjunction with FIG. 4. The control valve can be used to join the two working ports B, A alternatingly with the pressure port PA and outflow port T_{A}, and in a switching position simultaneously with the outflow port T_{A}, as has yet to be explained below (wherein an embodiment in which both working ports can be simultaneously joined with the pressure port PA is realizable).

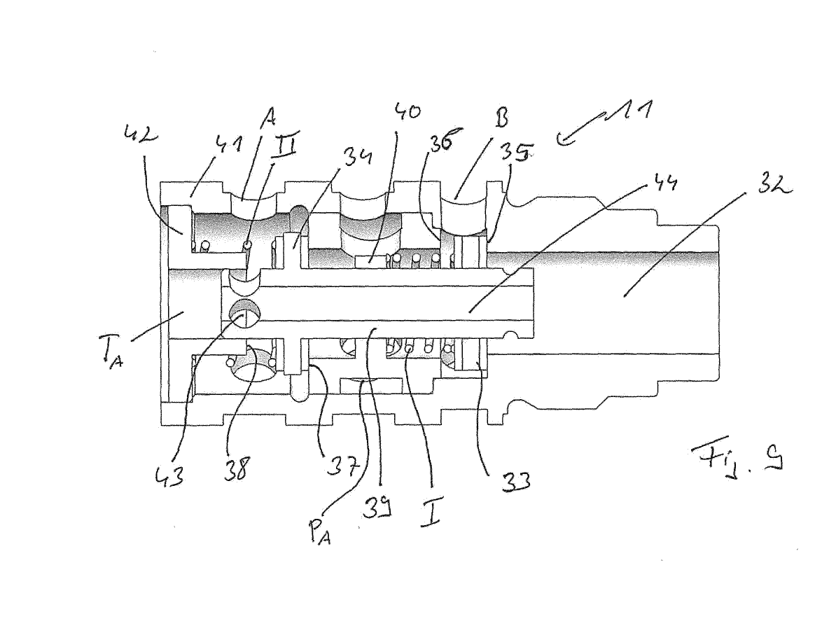

In the switching position depicted on FIG. 5, which corresponds to the right switching position of the control valve 11 according to FIG. 4, all springs I to III are only tensioned with their spring preload. The pressure port P_{A} is joined with the first working port B, and thus with the control chamber 19, while the fluid-conducting connection between the pressure port PA and second working port A is interrupted, but in return the second working port A is joined in a fluid-conducting manner with the outflow port T_{A} by way of the second valve body 34. The (minimal) spring forces of the springs I, II and III acting in this switching position are shown in the spring force diagram according to FIG. 8, specifically at operation point O₁ in the diagram, where the spring forces F of the three springs along with the sum of spring forces over the adjustment path of the valve actuator 32 or adjusting part 39 are recorded.

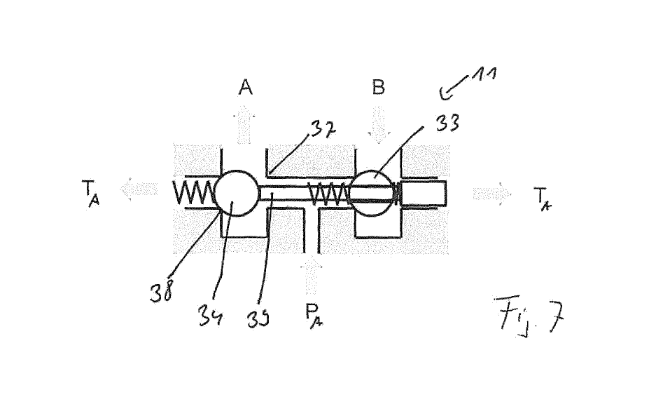

FIG. 6 shows an operation point O₂ or the middle switching position of the control valve according to FIG. 4, in which both working ports B, A are joined with the outflow port T_{A}, and hence with the suction side of the fluid circuit, while the pressure port P_{A} is completely blocked. As evident, the actuator 32 or a final control element of the actuator is displaced further to the left in the drawing plane, and hence the spring I [presses] the first valve 33 against the valve seat 36, which lies opposite the valve seat 35. The position of the second valve body 34 is unchanged. The resulting spring forces are here visible on FIG. 8 given O₂. In the position depicted, the adjustment element remains in the respectively current position, with there being no hydraulically resulting adjustment force.

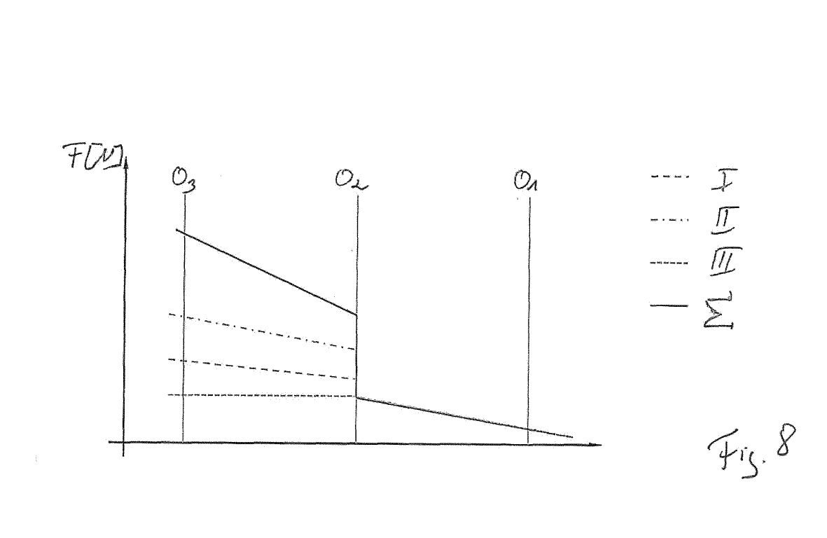

FIG. 7 now shows a valve position of the control valve 11 that corresponds to the illustration on the left of FIG. 4, in which the valve chamber 20 is joined with the pressure side of the cooling circuit, and the control chamber with the suction side. This is achieved by having the adjusting part 39 that penetrates the first valve body 33 displace the second valve body 34 against its valve seat 38 lying opposite the valve seat 37. As a consequence, the connection between the second working port A and pressure port T_{A} is interrupted, and the second working port A is joined with the pressure port P_{A} in a fluid-conducting manner, while the first working port A remains joined with the outflow port T_{A} by comparison with the working position O₂. The corresponding active spring forces can be read from the diagram according to FIG. 8 at O₃.

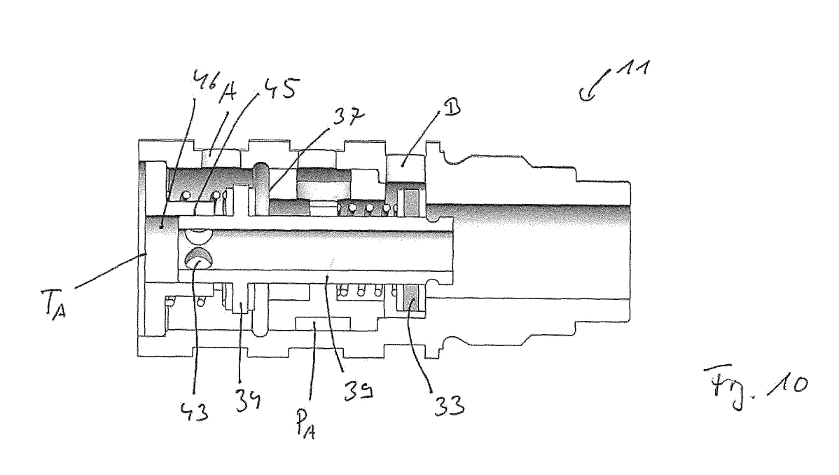

Shown on FIGS. 9 to 11 is an alternative, preferred embodiment variant of a preferably used control valve 11 with a 4/3-way functionality. The latter is configured in particular for a pressure-side use of the cooling medium valve in a cooling medium circuit, since, as has yet to be explained below, both the control chamber and valve chamber are joined with the pressure side of the cooling medium circuit in the middle control valve switching position. When interchanging the outflow port and pressure port, the control valve is designed in particular for a suction-side use of the cooling medium valve in a cooling medium circuit. The control valve can be activated with a single control valve actuator 32 (not shown in detail), and consists of two valve bodies, specifically a first valve body 33 and a second valve body 34, wherein the first valve body 33 closer to the actuator 32 can be displaced between two valve seats (switch valve seats) 35, 36, and the second valve body 34 can be displaced between a (switch) valve seat 37 and a valve seat 38 that can have a sealing function, but does not have to, based on the slider functionality yet to be explained. In this case, the other valve seat 38 is a stop, which limits the maximum displacement movement of the second valve body 34.

As evident from FIG. 9, the depicted control valve configured as a combined slide-multi-seat switch valve makes do with only two springs, specifically a first spring I and a second spring II—the additional spring referred to as the first spring and provided in the exemplary embodiment described before can be eliminated, since the adjusting part 39 is fixedly joined with the valve body 34 or monolithically configured with it in the embodiment according to FIGS. 9 to 11. In the exemplary embodiment described previously, however, the rod- or piston-shaped adjusting part 39, which can be displaced by means of the actuator 32, penetrates the first valve body 34, i.e., is displaceable relative thereto.

The first spring I is supported at one end against a thrust bearing 40 arranged between the valve bodies 33, 34, which is fixedly arranged relative to a control valve housing 41 via fixing means (not shown). At the other end, the first spring I is supported against the first valve body 33, and impinges the latter against the valve seat 35 immediately adjacent to the actuator 32 on the right of the drawing plane. The second spring II is supported at one end against another fixed thrust bearing 42, and at the other end on the second valve body 34, and impinges the latter together with the final control element 39 to the right in the drawing plane, or the second valve body 34 against its valve seat 37.

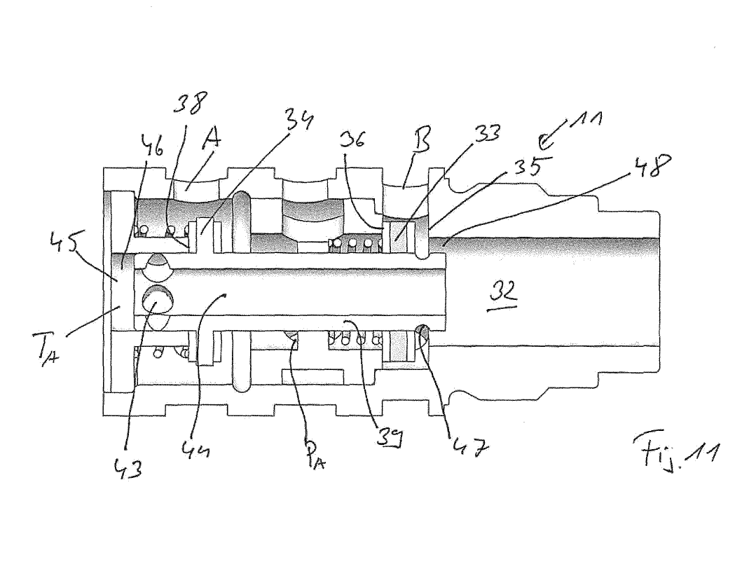

As in the exemplary embodiment described above, the control valve 11 consists of a pressure port P_{A}, an outflow port T_{A} as well as a first and second working port B, A, wherein the first working port B is joined with the control chamber, and the second working port A is joined with the valve chamber. The control valve 11 can be used to alternatingly join the two working ports B, A with the pressure port P_{A} and outflow port T_{A}, and in a switching position (see FIG. 10) simultaneously with the pressure port PA (wherein an embodiment can be realized here as well in which both working ports are simultaneously joined with the outflow port T_{A}).

In the switching position shown on FIG. 9, both springs I and II are only tensioned with their spring preload. The pressure port P_{A} is joined with the first working port B, and hence with the control chamber 19, while the fluid-conducting connection between the pressure port P_{A} and second working port A is interrupted. However, the second working port is joined in a fluid-conducting manner with the outflow port T_{A} via radial bores 43 in the adjusting part 39. Therefore, as opposed to the exemplary embodiment described above, a valve slide function is assigned to the adjusting part 39. For this purpose, an axial through bore 44 (through channel) is provided in the adjusting part 39, which is permanently joined in a fluid-conducting manner with the outflow port T_{A}, and which in the switching position depicted is joined with the second working port A via the radial bores 43. The (minimal) spring forces exerted by springs I and II in the switching position shown are depicted in the spring force diagram according to FIG. 12, specifically at operation point O₁ in the diagram, at which the spring forces F of the three springs along with the sum of spring forces is recorded over the of the adjustment path of the valve actuator 32 or adjusting part 39.

FIG. 10 shows an operation point O₂ or a middle switching position of the control valve 11 in which both working ports B, A are joined with the pressure port P_{A}, and hence with the pressure side of the fluid circuit, while the outflow port T_{A} is completely blocked. As evident, the actuator 32 or the adjusting part 39 has been displaced further to the left in the drawing plane through displacement of the actuator 32, so that the radial bores 43 are sealed by an (inner) circumferential wall 45 of a guiding channel 46 for the adjusting part 39 leading to the working port T_{A} in a fluid-conducting manner. The above illustrates the valve slide functionality of the adjusting part 39, which in the middle position shown interrupts the fluid-conducting connection between the second working port A, and hence the valve chamber and the outflow port T_{A}. At the same time, the second valve body 34 was axially lifted from is valve seat 37, thereby resulting in a fluid-conducting connection between the second working port A and pressure port P_{A}. Due to the unchanged valve position of the first valve body 33, the pressure port P_{A} remains joined with the first working port B in a fluid-conducting manner, so that both working ports A, B (as opposed to the exemplary embodiment according to FIGS. 5 to 7) are joined with the pressure side of the cooling medium circuit. The surfaces on the adjustment element are designed in such a way that no hydraulic adjustment force on the latter results in the respective adjustment element position at the operation point O₂ shown.

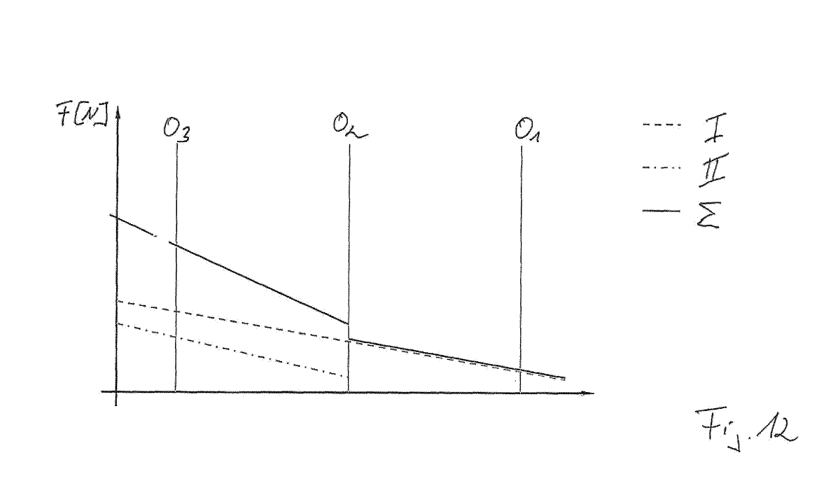

FIG. 11 now depicts a (completely through connected) valve position of the control valve 11, in which the valve chamber 20 is joined with the pressure side of the cooling circuit, and the control chamber with the suction side. Expressed differently, a fluid-conducting connection between the second working port A and pressure port PA exists in the operation point O₃ shown (see also spring force characteristic on FIG. 12), while the pressure port PA is decoupled from the first working port B, and hence from the control chamber. The latter is joined in a fluid-conducting manner with the outflow port T_{A} via the through bore 44 in the adjusting part 39. The existing interaction with the circumferential wall 45 of the guiding channel 46 keeps the radial bores 43 sealed.

In order to reach the valve position O₃ shown, the actuator 32 was used to displace the actuating part 39 further to the left in the drawing plane by comparison to the operation point O₂ according to FIG. 10, specifically until it hits the second valve body 34 against its stop or valve seat 38. Further displacing the adjusting part 39 causes it to take along the first valve body 33 toward the left in the drawing plane, i.e., lifting it from the valve seat 35, and displace it against the axially opposing additional valve seat 36. For example, this entrainment takes place via an annular element (not shown), which to this end is held in a circumferential annular groove 47 in the adjusting part 39. As a result, this interrupts the fluid-conducting connection between the pressure port PA and the first working port B, and opens the fluid-conducting connection between the first working port B and the outflow port T_{A}, since a control valve chamber 48 is permanently connected with the outflow port T_{A} in a fluid-conducting manner via the axial through bore 44, and is now joined with the first working port B in a fluid-conducting manner due to the valve body 33 being displaced away from the valve seat 35.

As in the exemplary embodiment according to FIGS. 5 to 7, the adjusting part 39 penetrates the first valve body 33, and can be displaced relative to it via the shared actuator 32, wherein the valve body 33 for the adjusting part 39 is axially entrained in a last adjusting stroke—because the second valve body 34 is integrally designed with the adjusting part 39, two of the valve bodies 34 and the adjusting part 39 are positively coupled—the closure functionality for decoupling the outflow port T_{A} from the second working port is there realized via the slider functionality of the adjusting part 39, as explained.

In an alternative embodiment variant, the outflow port T_{A} and pressure port PA and/or the working ports can be changed out. If the outflow port T_{A} and pressure port PA are interchanged in the control valve shown, both the control chamber 19 and valve chamber 20 of the cooling medium valve 8 are joined with the suction side of the cooling medium circuit in the middle switching position of the control valve 11, so that the control valve 11 can then be integrated into a cooling medium circuit in the manner depicted on FIG. 4. The switching position of the control valve according to FIG. 11 (with outflow and pressure ports interchanged) then corresponds to the right switching position of the control valve on FIG. 4. The middle switching position according to FIG. 10 (also once again with outflow and pressure port interchanged) corresponds to the middle switching position of the control valve 11 according to FIG. 4, and the switching position according to FIG. 9 (with outflow and pressure port interchanged) corresponds to the left switching position of the control valve according to FIG. 4.

### REFERENCE LIST

1 Cooling circuit arrangement
2 Engine
3 Cooling medium circuit
4 Cooling medium pump
5 Bypass fluid path
6 Cooler
7 Cooler fluid path
8 Cooling medium valve
9 Hydraulic actuator
10 Connecting line
11 Control valve
12 Outlet opening
13 Housing
14 Inlet
15 Outlet
16 Chamber
17 Adjustment element
18 Cylinder
19 Control chamber
20 Valve chamber
21 Return spring
22 Thrust bearing
23 Through opening
24 Annular slide
25 Shell surface section
26 Floor section
27 Openings
28 Chamber
29 Connecting channel (diverting line)
30 Control edge
31 Position sensor
32 Valve actuator
33 First valve body
34 Second valve body
35 Valve seat
36 Valve seat
37 Valve seat
38 Valve seat
39 Adjusting part
40 Thrust bearing
41 Control valve housing
42 Thrust bearing
43 Radial bore
44 Through bore
45 (Inner) circumferential wall
46 Guiding channel
47 Annular groove
48 Control valve chamber
A_{A} Working port of control valve
P_{A} Pressure port of control valve
T_{A} Outflow port of control valve
P Pressure side
S Suction side
B First working port
A Second working port
F Spring force
I First spring
II Second spring
III Third spring
First operation point
Second operation point
Third operation point

1. A cooling circuit arrangement (1) for cooling an engine (2), in particular a motor vehicle combustion engine, by means of a cooling medium, which can be conveyed by a cooling medium pump (4) between a suction side (S) and a pressure side (P) in a cooling medium circuit (3), which comprises a cooler fluid path (7) passing through a cooler (6) and a bypass fluid path (5), wherein a cooling medium valve (8) having an actuator (9) is arranged in the cooling medium circuit (3) for setting a volume flow ratio between cooling medium flows flowing through the cooler fluid path (7) and bypass fluid path (5),
characterized in that
the actuator (9) has a hydraulically activatable adjustment element (17), which can be supplied with cooling medium via at least one control valve (11) allocated to the cooling medium valve (8), in particular from the pressure side (P) out of the cooling medium circuit (3), in order to set the volume flow ratio.

2. The cooling circuit arrangement according to claim 1,
characterized in that,
by displacing the adjustment element (17), in particular by means of an annular slide (24) coupled with the adjustment element (17), a free flow cross section of a connection of an outlet (15) of the cooler fluid path (7) to the cooling medium pump (4) and/or a free flow cross section of an outlet (15) of the bypass fluid path (5) to the cooling medium pump (4) can be varied, or that, by displacing the adjustment element (17), in particular by means of the annular slide (24) coupled with the adjustment element (17), a free flow cross section of a connection of an inlet (14) of the cooler fluid path (7) to the cooling medium pump (4) and/or a free flow cross section of an inlet (14) of the bypass fluid path (5) to can be varied.

3. The cooling circuit arrangement according to one of claim 1 or 2,
characterized in that
the adjustment element (17) borders a control chamber (19) that can be supplied with the in particular pressure-side cooling medium via the at least one control valve (11), and preferably a valve chamber (20) also supplied with a cooling medium, in particular a suction-side cooling medium.

4. The cooling circuit arrangement according to claim 3,
characterized in that,
in order to displace the adjustment element (11), exclusively the control chamber (19) can be joined with the cooling circuit (3) by means of the at least one control valve (11), or the free flow cross section of such a connection can be varied, or, in order to displace the adjustment element (11), both the control chamber (19) and the valve chamber (20) can be joined with the cooling circuit (3) by means of the at least one control valve (11), or the free flow cross section of corresponding connections can be varied, and/or that, in order to maintain an adjustment element position, the at least one control valve (11) can be used to join both the control chamber (19) and valve chamber (20) with the cooling circuit, in particular on the same cooling circuit side, or the free flow cross section of corresponding connections can be varied.

5. The cooling circuit arrangement according to one of claim 3 or 4,
characterized in that,
in order to especially translationally displace the adjustment element (17) in a first displacement direction, the control chamber (19) can be joined by means of the at least one control valve (11) with the cooling medium circuit (3), in particular the pressure side (P) of the cooling medium circuit (3), and/or a free flow cross section of this connection can be enlarged, and that, in order to displace the adjustment element (17) in a second displacement direction opposite the first displacement direction, the at least one control valve (11) can be used to open a connection between the control chamber (19) and cooling medium circuit (3), preferably the suction side (S) of the cooling medium circuit (3), in particular inside of the cooling medium valve (8) and/or a free flow cross section of this connection can be enlarged.

6. The cooling circuit arrangement according to one of claim 3 or 4,
characterized in that,
in order to especially translationally displace the adjustment element (17) in a first displacement direction by means of the at least [one] control valve (11), the control chamber (19) can be joined with the pressure side (P) of the cooling medium circuit (3) and the valve chamber (20) with the suction side (S) of the cooling medium circuit (3), or the free flow cross section of the respective connection can be varied, in particular enlarged, and that, in order to displace the adjustment element in a second displacement direction opposite the first displacement direction, the at least [one] control valve (11) can be used to join the valve chamber (20) with the pressure side (P) of the cooling medium circuit (3) and the control chamber (19) with the suction side (S) of the cooling medium circuit (3), or the free flow cross section of the respective connection can be varied, in particular enlarged, and/or that, in order to maintain an adjustment element position, the at least one control valve (11) can be used to join both the control chamber (19) and valve chamber (20) with the pressure side (P) of the cooling circuit, or alternatively the suction side (S) of the cooling circuit, or the free flow cross section of corresponding connections can be varied.

7. The cooling circuit arrangement according to one of claims 3 to 6,
characterized in that
the control chamber (19) and valve chamber (20) are arranged in a cylinder (18) that envelops the adjustment element (17), which is preferably piston-shaped and translationally displaceable.

8. The cooling circuit arrangement according to one of claims 3 to 7,
characterized in that
a leakage fluid path is provided between the control chamber (19) and valve chamber (20), through which a cooling medium leakage fluid path can flow out of the control chamber (19) into the valve chamber (20), in particular outside passing by the adjustment element (17).

9. The cooling circuit arrangement according to one of the preceding claims,
characterized in that
the at least one control valve (11) is designed and/or actuated as a preferably solenoid, in particular PWM actuated, proportional valve, or as a preferably solenoid, in particularly discretely switching switch valve, and/or that the at least one control valve (11) is designed as a multi-seat switch valve or as a combined slide/multi-seat switch valve, preferably each as a 4/3-way valve, which consists of two valve bodies (33, 34) that can be displaced with a shared actuator, wherein one of the valve bodies is preferably penetrated by an adjusting part that can be displaced by means of the actuator, in particular a piston, in order to displace the other valve body, wherein the adjusting part (39) can preferably be displaced either exclusively relative to one of the valve bodies (33, 34) or alternatively relative to both of the valve bodies (33, 34).

10. The cooling circuit arrangement according to one of the preceding claims,
characterized in that
the control valve (11) can be and/or is actuated by way of a control unit that preferably consists of a thermal switch and is joined with the control valve (11) in a signal-conducting manner in such a way that the adjustment element (17), preferably exclusively, can assume two stable adjustment positions, which each define a fixed volume flow ratio, preferably a first adjustment position in which the entire cooling medium flows through the cooler fluid path (7) and/or a second adjustment position in which the entire cooling medium or a portion of the cooling medium flows through the bypass fluid path (5), or that the control valve (11) can be and/or is actuated by way of a control unit joined with the control valve (11) in a signal-conducting manner in such a way that the adjustment element can assume a plurality of adjustment positions, in particular more than two, preferably more than three, further preferably more than ten, which each result in volume flow ratios that differ from each other.

11. The cooling circuit arrangement according to one of the preceding claims,
characterized in that
the control valve (11) is a 3/2-way valve, which preferentially has a preferably pressure-side cooling medium pressure port (PA), a preferably suction-side cooling medium outflow port (T_{A}), and an adjustment-side cooling medium working port (AA), or that the at least one control valve (11) has a 4/3-way valve functionality and a preferably pressure-side cooling medium pressure port (P), a preferably suction-side cooling medium outflow port (T), a first working port (B) leading to the control chamber (19) and a second working port (A) leading to the valve chamber (20).

12. The cooling circuit arrangement according to one of the preceding claims,
characterized in that
the at least one control valve (11) can be actuated by way of a control unit, preferably as a function of an engine temperature-dependent temperature signal and/or independently of the engine temperature signal, wherein, in order to determine an ACTUAL volume flow ratio, the control unit is joined with a position sensor (31) in a signal-conducting manner to detect the position of the adjustment element.

13. The cooling circuit arrangement according to one of the preceding claims,
characterized in that
the adjustment element (19) can be displaced against the spring force of a return spring by supplying it with in particular a pressure-side cooling medium, or that the adjustment element (17) can be displaced in both opposite displacement directions exclusively by being hydraulically pressurized by means of the cooling element.

14. The cooling circuit arrangement according to one of the preceding claims,
characterized in that
the cooling medium pump (4) is arranged in such a way that the cooling medium flows out of the pump to the engine (2), and that, after the engine (2), the cooling medium circuit (3) branches into the bypass fluid path (5) and cooler fluid path (7).

15. A method for cooling an engine (2), in particular a motor vehicle combustion engine, in particular by means of a cooling circuit arrangement (1) according to one of the preceding claims, wherein cooling medium is conveyed between a suction side (S) and a pressure side (P) in a cooling medium circuit (3), which consists of a cooler fluid path (7) leading through a cooler (6) and a bypass fluid path (5), wherein a volume flow ratio between the cooling medium volume flows flowing through the cooler fluid path (7) and bypass fluid path (5) is set by means of a cooling medium valve (8) that is arranged in the cooling medium circuit (3) and has an actuator (2),
characterized in that
the actuator (2) has a hydraulically activatable adjustment element (17), which is supplied with cooling medium from the cooling medium circuit (3), in particular from the pressure side (P) of the cooling medium circuit (3), in order to set the volume flow ratio by way of a control valve (11) allocated to the cooling medium valve (8).

16. The method according to claim 15,
characterized in that
the adjustment element (17) is supplied with the in particular pressure-side cooling medium for displacement in a first displacement direction, and that this supply of cooling medium to the adjustment element (17) for displacing the adjustment element (17) in a second displacement direction opposite the first displacement direction is reduced, in that the cooling medium supplied to the adjustment element (17) is at least partially discharged into the cooling medium circuit (3), preferably toward the suction side (S) of the cooling medium circuit (3), in particular inside of the cooling medium valve (8).

17. The method according to claim 15,
characterized in that
the adjustment element (17) preferably not exposed to the force of a return spring is displaced in a first displacement direction by using the at least one control valve (11) to guide preferably pressure-side cooling medium out of the cooling medium circuit into the control chamber (19) and having the cooling medium be discharged via the at least one control valve (11) out of the valve chamber (20), in particular toward the suction side (S) and into the cooling medium circuit, and that the adjustment element (17) is displaced in an adjustment direction opposite the first displacement direction by using the at least one control valve (11) to guide preferably pressure-side cooling medium out of the cooling medium circuit into the valve chamber (20), and having cooling medium be discharged via the at least one control valve (11) out of the control chamber (19), in particular toward the suction side (S) and into the cooling medium circuit, and/or that, to maintain an adjustment element position, both the control chamber (19) and valve chamber (20) are joined in a fluid-conducting manner with the cooling circuit, preferably both with the suction side (S) or alternatively with the pressure side (P), by means of the at least one control valve (11).

18. The method according to one of claims 15 to 17,
characterized in that
the at least one control valve (11) is actuated in such a way that the adjustment element (17) is displaced exclusively between two stable adjustment positions, or that the adjustment element (17) is displaced between more than two stable adjustment positions, in particular a plurality of intermediate positions between two extreme positions, which differ with respect to the volume flow ratio.
